(19) United States
(12) Patent Application Publication
(10) Pub. No.: US 2022/0245597 A1
(43) Pub. Date: Aug. 4, 2022

(54) SYSTEM AND METHOD FOR MANAGING EVENT DATA

(71) Applicant: Kognitiv, Inc., Newton, MA (US)

(72) Inventor: Rodney Jones, Rolling Hills Estates, CA (US)

(73) Assignee: Kognitiv, Inc., Newton, MA (US)

(21) Appl. No.: 17/588,904

(22) Filed: Jan. 31, 2022

Related U.S. Application Data
(60) Provisional application No. 63/144,158, filed on Feb. 1, 2021.

(51) Int. Cl. G06Q 10/10

(52) U.S. Cl. CPC G06Q 10/1095

(57) ABSTRACT

A system is provided that includes a coordination system that is configured to perform one or more coordinated operations across a number of domains and system types. In some embodiments, the coordination system may be adapted to communicate with an applicant tracking system (ATS). Further, the coordination system may be adapted to communicate with one or more email systems, calendar systems or components, conferencing systems, location management systems, and/or one or more messaging systems. Different types of users each having varying roles may interoperate with the various interconnected systems. In some embodiments, a coordination functionality is provided via the coordination system that is used to reduce the number of user operations required in relation to scheduling and maintaining events.

### RELATED APPLICATIONS

This application is a Non-Provisional of Provisional (35 USC 119(e)) of U.S. Application Ser. No. 63/144,158, filed Feb. 1, 2021, entitled “SYSTEM AND METHOD FOR MANAGING EVENT DATA”. The entire contents of this application are incorporated herein by reference.

### BACKGROUND

There are multiple systems that exist that permit users to collaborate and communicate in many different media types and different platforms. There are challenges with integrating such platforms, and users generally have to be conversant in many different application applications and their interfaces to accomplish their everyday tasks.

### SUMMARY

It is appreciated that companies often juggle multiple platforms to manage the simple task of scheduling an event, such as a candidate interview. In some aspects as described herein, it is realized that Applicant Tracking Systems (ATS), email systems, video conferencing systems, calendars, and other systems are disjointed and information relating to event are never stored and accessed ‘in one place’. In some embodiments as described herein, systems and methods are provided to coordinate functions among multiple disparate systems, and for allowing information relating to events to be accessed from multiple systems.

Many of these common issues occur within enterprise systems such as a corporate data network. There may be, for example, in large companies having multiple divisions and locations, multiple systems that do not coordinate event data. It is appreciated that such systems do not communicate efficiently and completely as many times they are programmed for different audiences, are created by multiple vendors and therefore interoperability is lacking. Further, in some configurations such as in a large enterprise environment, multiple domains are used that correspond to these logical company divisions, and therefore, these systems are not interoperable in a transparent way. In one specific example, to schedule an event among a number of different calendaring systems (e.g., Microsoft Office/Outlook 365, Google GSuite), often with different domains, it becomes difficult to schedule and manage events for their constituent users, as these different domains do not share calendar-related information for their users, and availability of users cannot be accomplished without some necessary manual intervention (e.g., manually sending emails among users to find available times). Such issues are even more complicated when dealing with users outside of the enterprise, as their associated systems are different and do not share information.

In some aspects described herein, systems and methods are provided that permit multiple-domain functionality across disparate systems. For example, a coordination system may be provided that is capable of communicating among disparate systems and domains for the purpose of coordinating an event across these domains and systems. For example, in one specific event such as a job interview, a coordination system may be provided that determines, for a number of users across domains, availability information and can determine, automatically, a common available timeslot for scheduling the event. Further, the system may be capable of automatically storing and updating calendar information across these domains and systems without manual intervention. By reducing the number of user operations necessary to maintain their calendar information, the efficiency of the computers is increased.

According to one aspect, a system is provided comprising a plurality of computer-implemented domains, each domain comprising a plurality of users, each of which includes at least one calendar database comprising a plurality of events; a coordination element configured to perform an inter-domain function among at least two calendar databases associated with two respective users, the two users located within different domains, wherein the coordination element is adapted to query the at least two calendar databases associated with the two respective users of the different domains and determine at least one potential common attribute for determining a new event; communicating the at least one common attribute for a proposed new event; and creating, responsive to indications from the two respective users that the proposed new event is accepted, events in each one of the calendar databases of the two respective users. According to one embodiment, at least one common attribute is an availability indication among the calendar databases of the two respective users. According to one embodiment, the coordination element is adapted to coordinate with a plurality of computer platform types associated with the plurality of computer-implemented domains, wherein the plurality of computer platform types includes a group comprising a messaging system; an email system; a calendar management system; a conferencing system; a location management system; and an applicant tracking system (ATS). According to one embodiment, the coordination element is configured to perform at least one function. According to one embodiment, the new event is a web conference, and wherein the at least one function comprises automatically adding, by the coordination system, additional users that did not create the web conference as alternate hosts to the web conference. According to one embodiment, the additional users are permitted to manage the web conference independently of a creator of the web conference.

According to one embodiment, the coordination element is configured to automatically grant access rights to a shared account associated with the new event. According to one embodiment, the shared account is at least one of a group comprising a calendar account, an email account, or a video conferencing account. According to one embodiment, the coordination element is configured to automatically grant rights to a group of users to the shared account. According to one embodiment, the system further comprising an interface adapted to permit a managing user to create a rule that controls the coordination element to perform at least one action. According to one embodiment, the rule controls the coordination element to automatically cancel the new event when one or more users associated with the new event decline to attend the new event within a computer interface. According to one embodiment, the rule controls the coordination element to automatically place the new event on a secondary calendar of a coordinating user that created the new event. According to one embodiment, the rule controls the coordination element to automatically mark the new event as free on a calendar of a coordinating user that created the new event. According to one embodiment, the coordination element is configured to automatically send a message to a coordinating user to reschedule the new event responsive to receiving an indication of a declination to attend the new event by the one or more users associated with the new event, at least two of the one or more users being assigned to different domains. According to one embodiment, a user component is adapted to send the coordination element a requested new event with at least a start time and an end time, and a plurality of invited users for the requested new event. According to one embodiment, the coordination element is adapted to determine if the plurality of invited users are available to attend the requested new event. According to one embodiment, the coordination element is adapted to return an indication of a common availability of the one or more users associated with the new event.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows one implementation of a distributed computer system 100 that is capable of implementing various aspects;

FIG. 2 shows on implementation of a distributed system 200 where multiple domains are implemented according to some embodiments;

FIG. 3 shows one example of a coordination of an event according to some embodiments;

FIG. 4 shows a process for coordinating event information according to various embodiments;

FIG. 5 shows a more detailed system for coordinating event information according to various embodiments;

FIG. 6 shows one example user interface for editing templates for automatic messages according to some embodiments;

FIG. 7 shows an example interface that enables users to schedule events in bulk, reducing the number of user operations, according to some embodiments;

FIG. 8 shows one example user interface that permits coordination among a number of users for an event according to some embodiments;

FIG. 9 shows one example user interface that permits a user to select a time for an interview among a number of users according to some embodiments;

FIG. 10 shows one example of an interface that may be used to display metrics gathered regarding an event-setting process;

FIG. 11 shows another example interface showing detailed statistics showing user performance relating to an event-setting process according to some embodiments;

FIG. 12 shows an example interface showing detailed statistics showing user performance relating to an event-setting process according to some embodiments; and

FIG. 13 shows one example interface showing reasons for cancellation of an event (e.g., an interview event) according to some embodiments.

### DETAILED DESCRIPTION OF DRAWINGS

As discussed, it would be helpful from a user perspective to permit additional functionality from a number of disparate systems that access event data. For instance, in scheduling a single event such as a job interview, multiple different systems may be required. In a typical scheduling scenario, a user (e.g., a recruiting coordinator user type) may schedule an event to interview an outside candidate with one or more internal reviewers using an applicant tracking system as known in the art. An example of such a system includes the Workday Applicant Tracking System (ATS) available commercially from Workday, Inc., although there are many ATS systems available. In such a system, a user may select, within the application interface, a number of reviewers, a candidate, and one or more resources (e.g., conferencing resources, physical resources (e.g., conference rooms)) that can be used for the interview.

It is appreciated that this one action involves a number of systems and accounts that needs to manage information relating to the event. For instance, there may be multiple email accounts for the candidate and/or reviewing users that must be accessed, each having an associated calendar database. Because many of these email accounts are in different domains, it is appreciated that information such as availability is not shared across domains. Further, the event may require separate resources that may be tracked by even more systems, such as a conference room or videoconference database. Many times, there are conflicting requests for such resources, and it would be helpful to have an automatic coordination function to allocate resources and communicate updates relating to the event. Further, it would be helpful and more convenient to perform such operations using a mobile device, SMS capability, and/or by performing operations within the calendaring function of the user platform or ATS system.

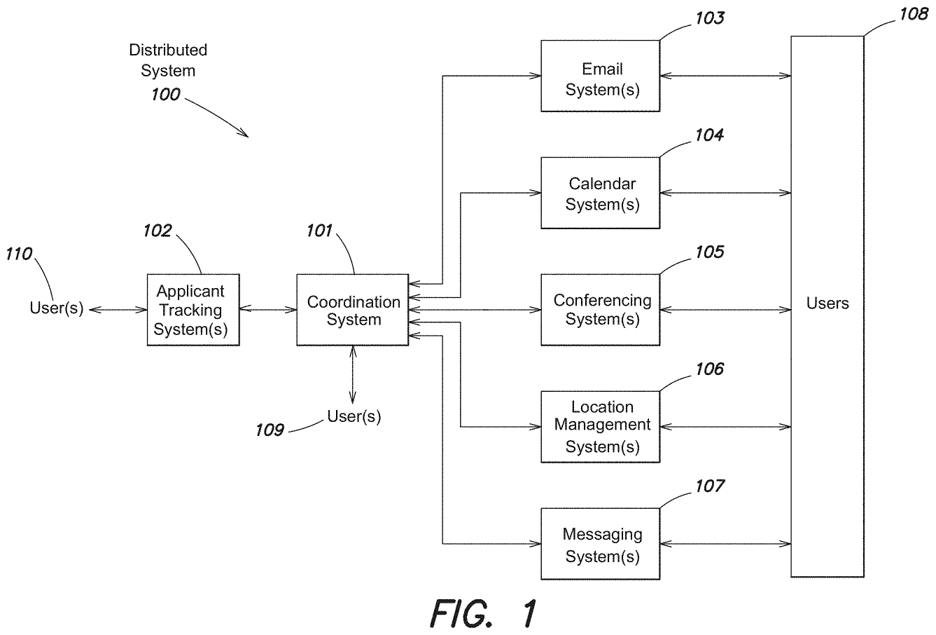

FIG. 1 shows one implementation of a distributed computer system 100 that is capable of implementing various embodiments. System 100 may include a coordination system 101 that is configured to perform one or more coordinated operations across a number of domains and system types. In some embodiments, coordination system may be adapted to communicate with an applicant tracking system or ATS (e.g., system 102). Further, coordination system may be adapted to communicate with one or more email systems (e.g., system 103), calendar systems or components (e.g., system 104), conferencing systems (e.g., system 105), location management systems (e.g., system 106), and/or one or more messaging systems (e.g., system 107). Different types of users (e.g., users 110, users 109, users 108), each having varying roles may interoperate with the various interconnected systems. In some embodiments, coordination functionality is provided via a coordination system 101 that is used to reduce the number of user operations required in relation to scheduling and maintaining events. In some embodiments, it is appreciated that coordination system 101 may provide multiple domain functionality. For instance, clients can schedule across multiple email systems e.g. Microsoft Office/Outlook 365 and Google GSuite, each with multiple email domains, at the same time. This functionality may be extended to Web conferencing solutions as well. For example, such capabilities may be provide using certain technologies and interfaces such as Open ID OAuth 2.0, Microsoft Graph OAuth2.0 REST/JSON API, Google GSuite OAuth2.0 REST/JSON API, among others.

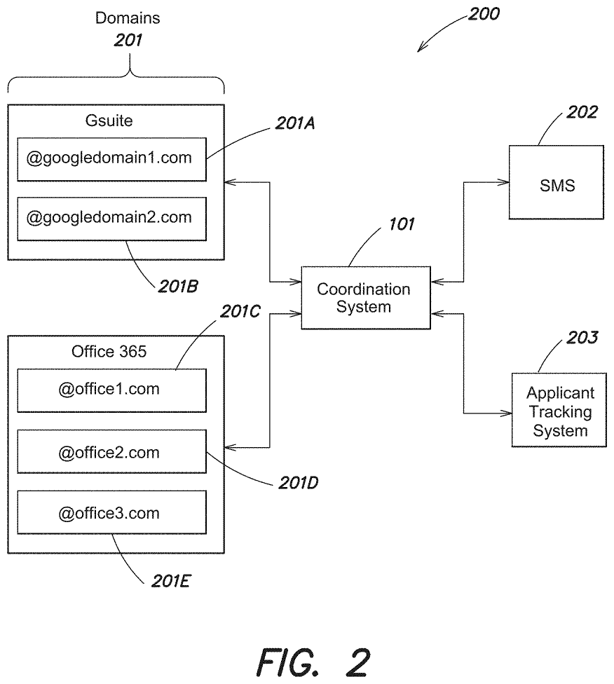

FIG. 2 shows one implementation of a distributed system 200 where multiple domains 201 are implemented. In the example shown, coordination system 101 is configured to communicate between the domains 201 to create and manage an event. For instance, domains 201 may include domains across subdomains of the same (e.g., 2 Google GSuite domains @googledomain1.com and @googledomain2.com) or different platforms (e.g., 3 Office 365 domains @office1.com, @office2.com and @office3.com). Coordination system 101 may permit a user to see the free/busy calendars and schedule meetings with users from users in all five domains at once in the same meeting/event.

Further, coordination system 101 may be integrated within an ATS (e.g., ATS 203) whereby a managing user such as an event coordinator is provided functions within the ATS interface that permits them to schedule events among a number of coordinated domains. Moreover, the system may include additional functionality that allows users to schedule and manage events more easily. For instance, the coordination system may be configured to communicate with an SMS system 202 for the purpose of communicating with users to schedule and manage events, among other event-related functions without needing to launch a calendar application or email-based system. Other messaging systems may be used to communicate information as appropriate to users (e.g., WhatsApp, Slack, Teams, etc.).

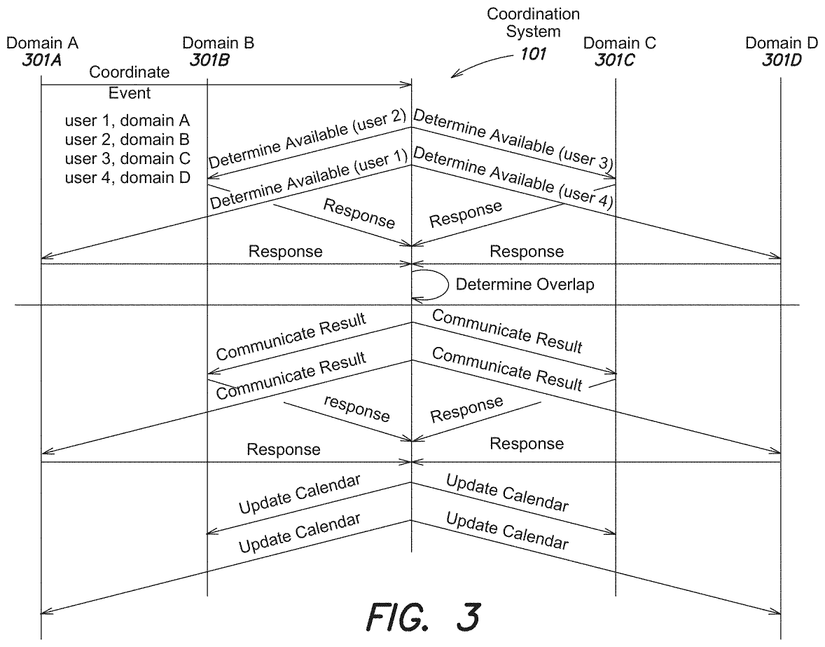

FIG. 3 shows one example of a coordination of an event according to some embodiments. As shown, there are multiple users (users 1-4) located logically across a number of domains (e.g., domain A 301A, domain B 301B, domain C 301C, and domain D 301D). In one example, one user (user 1 from domain A 301A) initiates an action to the coordination system 101 to coordinate an event among the four users from different domains. Responsive to the request, the coordination system initiates a query regarding the availabilities of the four users to each of the domains where the users reside. This may be performed, for example, using one or more APIs or interfaces to service points for each of the services that are required (e.g., calendar request, call to a videoconference account for information, etc.). Responses are received by the coordination system 101 and, for an availability determination, the coordination system determines the available overlap between the user schedules. The coordination system may also determine other parameters as well, such as for an interview, of what users are available, any resources needed for the event, such as conference room, videoconference channel, etc., and may communicate the information to the appropriate users.

One or more results may be generated to the users based on their system/platform/communication channel, and the users may accept the request. If accepted, the communication system may update user calendars and/or update a centralized calendar that includes information for all of the users. For instance, there may be a centralized calendar for a role (e.g., a coordinator), such as in an ATS that tracks interviews of multiple candidates that require multiple parties to be tracked on the calendar who are not owners of the centralized calendar.

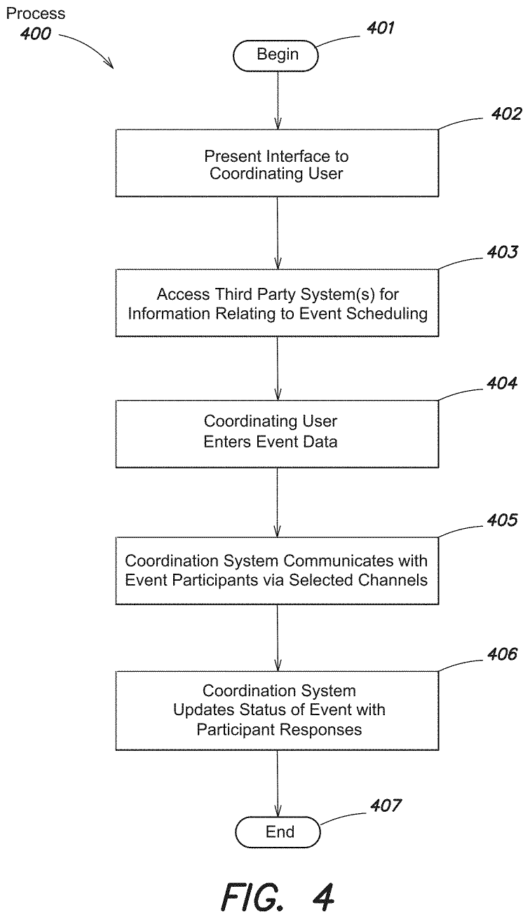

FIG. 4 shows a process 400 for coordinating event information according to various embodiments. At block 401, process 400 begins. At block 402, the coordination system (e.g. coordination system 101) presents an interface to a coordinating user. Within the system interface, a coordinating user can configure one or more workflows associated with an event scheduling operation. Responsive to these user configurations, the system may at block 403 access one or more third-party systems for information relating to event scheduling. The event may involve, for example, one or more users having different role types (e.g., interviewer, interviewee/candidate, or other role type). As discussed, a coordination system according to various embodiments may integrate one or more systems such and eat as an email system, calendar system, conferencing system, location management system, and/or one or more messaging systems.

At block 404, the coordinating user enters event data within the presented interface. Responsive to this information, the coronation system communicates with event participants via one or more select channels at block 405. Because the coordination system automatically performs certain operations and communicate within certain types of communication channels, the number of user operations required for coordinating an event is reduced. Further, at block 406, the coordination system updates the status of an event with participant responses. The status of the event may be communicated to other users, a coordinating user, or its information may be correlated with a number of statistics and display to a managing user (e.g., within a management interface) for the purpose of managing the event creation process. At block 407, process 400 ends.

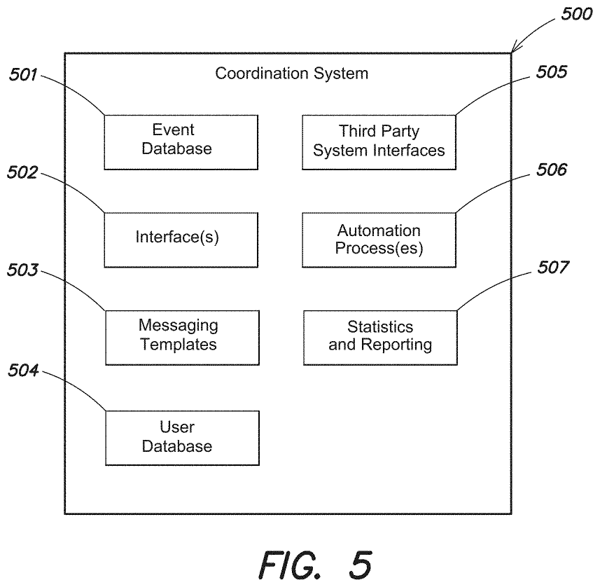

FIG. 5 shows a more detailed system for coordinating event information according to various embodiments. In particular, FIG. 5 shows a coordination system 500 which includes a number of subcomponents that perform particular operations or functions. For example, coordination system 500 maintains an event database 501 which includes information regarding particular events that are coordinated among multiple systems and domains. Further, system 500 includes one or more interfaces 5024 permitting configuration and management of particular events. In addition, the system may include one or more messaging templates (e.g., templates 503) the permit or more ranging user to configure specific messages and formats that may be communicated among users. For instance, the system may include a template for an SMS message to be sent via an SMS channel to allow a user to more quickly respond to an interview request. Such capability is typically performed within a resident application, such as a calendar function, ATS or other application requiring multiple user operations to login and accept requests.

System 500 may also include a user database 504 which includes information relating to particular user types, individual users, preferences, domain information, access control information, among other information. To achieve coordination with one or more third-party systems, system 500 includes one or more third-party system interfaces 505 which includes functionality that is used to natively interoperate with third party systems (e.g., via an API, call, or other process communication). System 500 may also include one or more automation processes 506 that combine or replace traditional user functionality. Such processes may include multiple operations or steps that may be performed by or on a number of disparate systems. Because coordination system 500 is interposed within the scheduling process, one or more statistics may be collected by the system. To this end, system 500 may include a component 507 that performs statistics and reporting functions for one or more users (e.g., a managing user). In this manner, the overall communication process for scheduling an event may be monitored, optimized, and managed.

Example Coordination Functions

Described below are several embodiments of functionality that may be performed by a coordination system (e.g., coordination system 101, coordination system 500, etc.). Such functionalities may result in less user operations required for managing the creation of events among users located within multiple, and in some cases, the same domains.

(1) Accept/Decline SMS and Calendar Integration

When a user accepts or declines a meeting invitation (e.g., via SMS), the acceptance or decline is automatically reflected in the coordinator's calendar as well according to some embodiments. This may be accomplished, for example, by a coordination function that connects an SMS system and a scheduling function that is adapted to access the coordinator's calendar.

### Example

Technologies used: Twilio SMS API for SMS functionality and Firebase Functions for handling the calendar update/webhook callback logic.

### Use Cases/Examples

1. Client sends an interview event calendar invite to a potential candidate and checks the option to send an SMS as well.
2. Candidate receives an email with the option to accept/decline the event invite along with an SMS:
   a. Invitation: Candidate Interview: INT System Administrator (G-Suite) @ Tue, Dec. 22, 2020 5:45 AM—6:45 AM (EST)—Type A to Accept or D to Decline
3. The Candidate can either accept or decline using the provided buttons in the email or they can reply to the SMS.
4. On accepting or declining using the SMS channel, Twilio's API will send the coordination system a callback which will notify the coordination system of the response.
5. The coordination system will then update the organizer's calendar to reflect the response.
6. All the SMS messages exchanged will be logged to an Audit Logger which the organizer (or anyone with access to the Job Application on the coordination system) can view along with their delivery (sent, queued, failed, received) status.

(2) Book Calendar Invitations Via SMS/Text

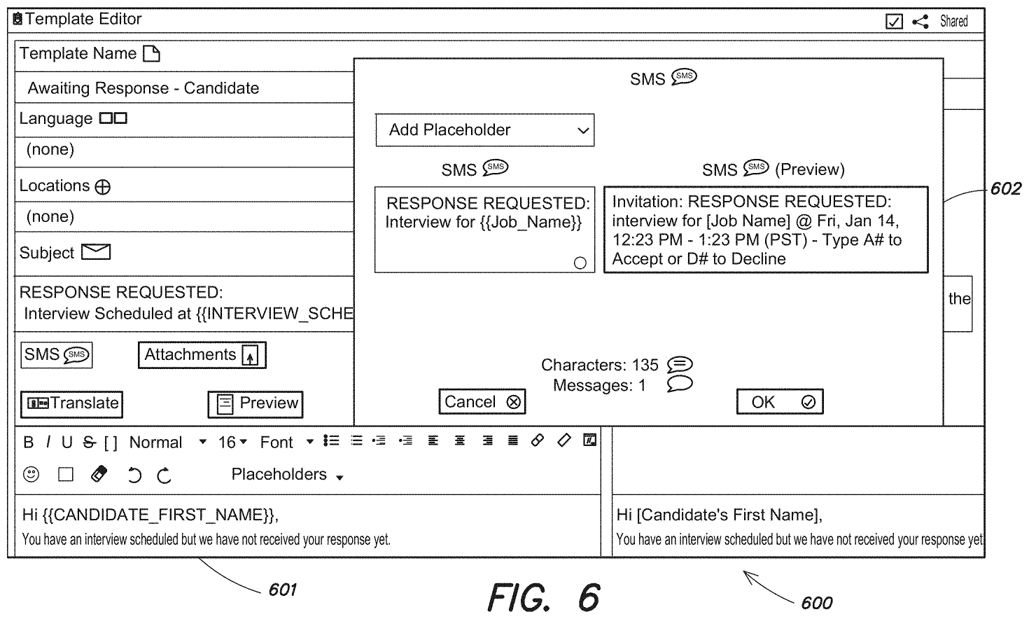

In some embodiments, a coordination function is provided that permits candidates to book their interviews by text message. Similar to the example above, a coordination function that connects SMS and a scheduling function may be used. This includes the ability to send reminders (e.g., via SMS, text, etc.) as well, allowing the candidate user to accept or decline via this reminder. For example, FIG. 6 shows one example user interface 600 for editing templates for automatic messages according to some embodiments. In particular, interface 600 includes a template editor 601 that permits the user to customize messages and formats relating to messages that may be automatically sent in relation to the scheduling of an event. In some embodiments, the messages may have predefined formats and pull from event data that is created and tracked through a coordination system (e.g., coordination system 101). To this end, the system may include one or more interfaces that show a particular message type (e.g., SMS window 602) that allows the user to customize message content, format, and/or response types to the message.

(3) Bulk Actions

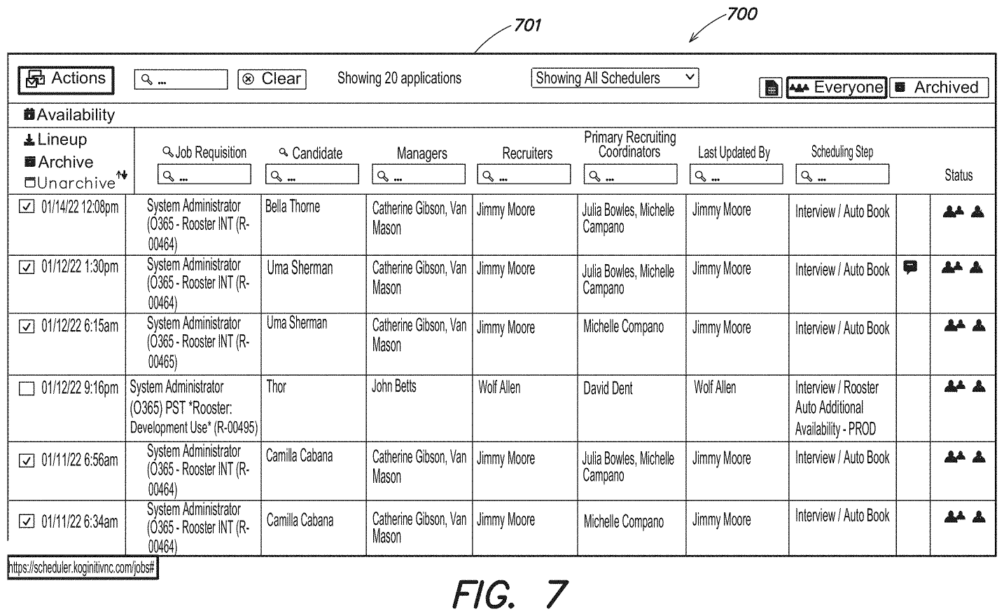

In some embodiments, functionality is provided within an interface to permit a user to book interviews and request availability en-masse with two clicks of a button (e.g., even without exiting the ATS) via direct integrations. In payments, an interview request is sent to the candidate user using full automation without any interaction other than the existing interaction with the existing AT optionally, bulk actions may be accomplished by the system itself instead of using full automation within the ATS. For example, FIG. 7 shows an example interface 700 that enables users to schedule events in bulk, reducing the number of user operations, according to some embodiments. In particular, FIG. 7 shows an interface 700 that permits a user to configure bulk events (e.g., multiple interview events) from a single interface. For example, interface 700 may include at least one portion 701 that permits the user to perform one or more actions in relation to multiple events. The system may include status information showing, for example, various candidates, managers, recruiters, coordinators and other information associated with a particular job interview event. The interface may also include indicators that show various statuses of the process including update information as well as scheduling steps associated with those particular events. Him

(4) Automatic Scheduling Using Candidate and Interviewer Availability

Candidate and interviewer availability (e.g., as requested above using Bulk Actions) is used to manually or automatically book interviews using the intersection of free times from both.

### Example

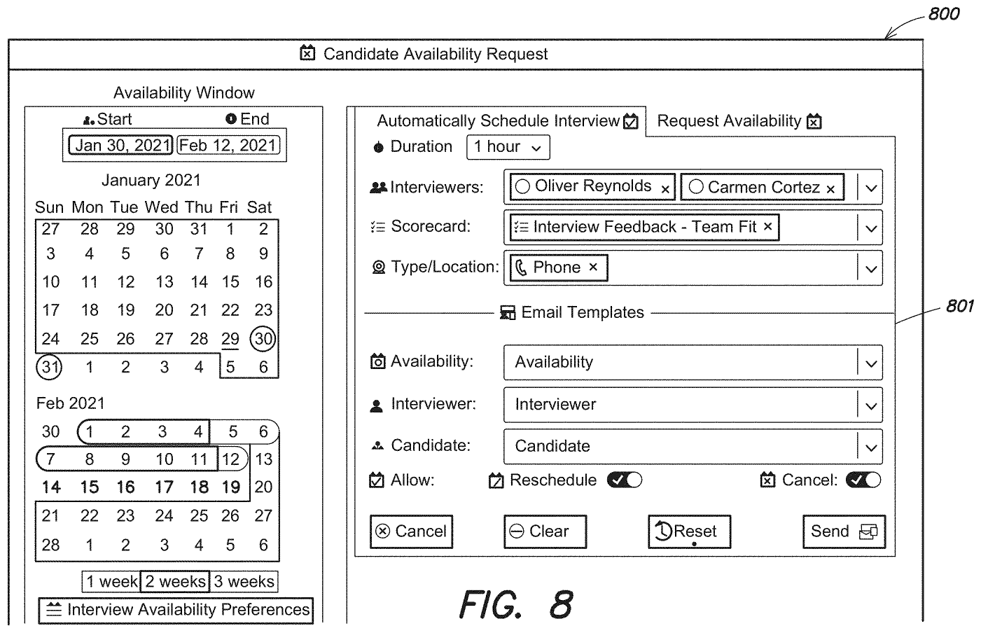

A Scheduler sends an availability request to the candidate using the interface 800 as shown in FIG. 8. 1. Scheduler chooses an availability window, duration, interviewers, templates and other options.

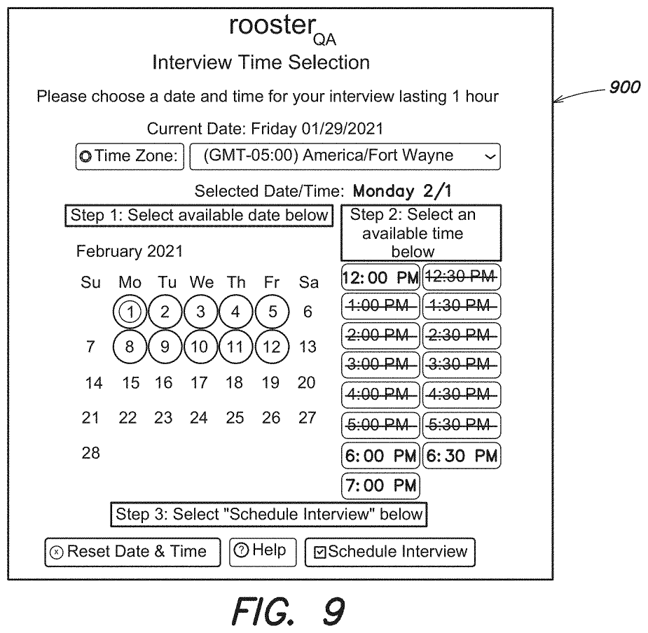

2. The candidate then receives an email with the link to choose his availability. FIG. 9 shows an interface 900 that includes controls where a user may choose their availability and communicate it back to the coordination system.

3. In some embodiments, the system includes an interface that allows the candidate to select their availability from the available slots (e.g., times where the interviewer's calendar is marked busy as shown in grey or highlighted otherwise) and clicks on “Schedule Interview” to schedule the interview event at the provided time.

4. The event is automatically be created in the scheduler's calendar with the interviewers as attendees by the coordination system.

The system may also prevent one or more interfaces 801 including one or more controls that permit the user to customize what users receive information, what message templates may be used, which users are to be contacted, etc.

(5) Real-Time Data on Interviewers During Scheduling of Interviews

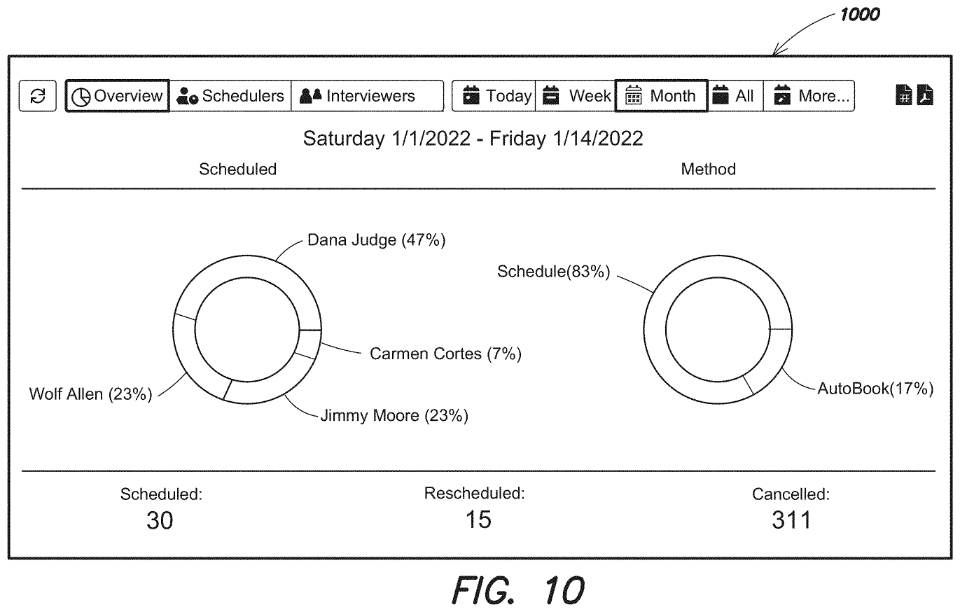

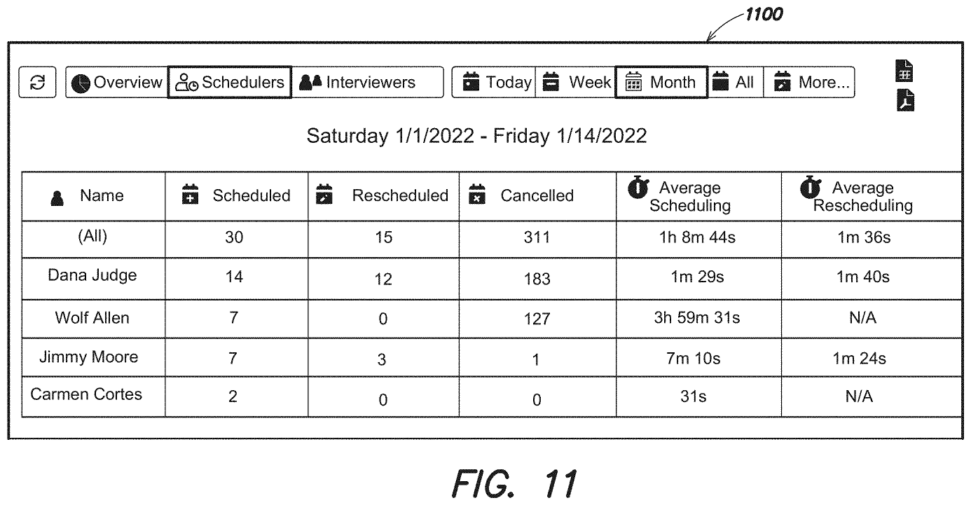

In some embodiments, the coordination system may determine statistics or other metrics on how particular users perform in the communication process associated with some events. For example, metrics such as how often interviewers accept, decline or do not reply to interview requests, along with how long it takes them to respond on average. Such metrics may be compiled and arranged in an interface to inform a user (e.g., a manager) on how the event scheduling process is performing. FIG. 10 shows one example of an interface 1000 that may be used to display metrics gathered regarding an event-setting process. FIG. 11 shows another example interface showing detailed statistics showing user performance relating to an event-setting process according to some embodiments.

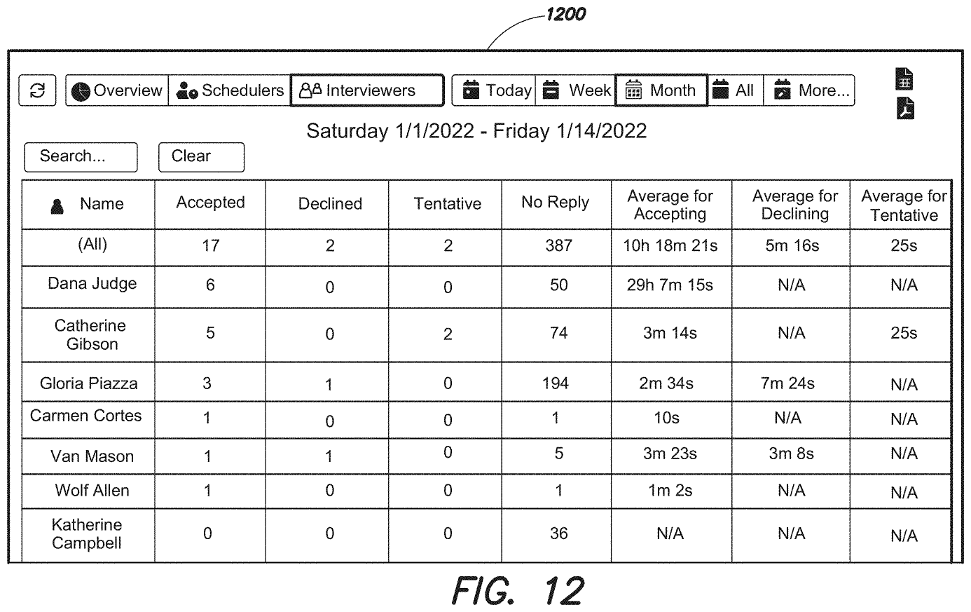

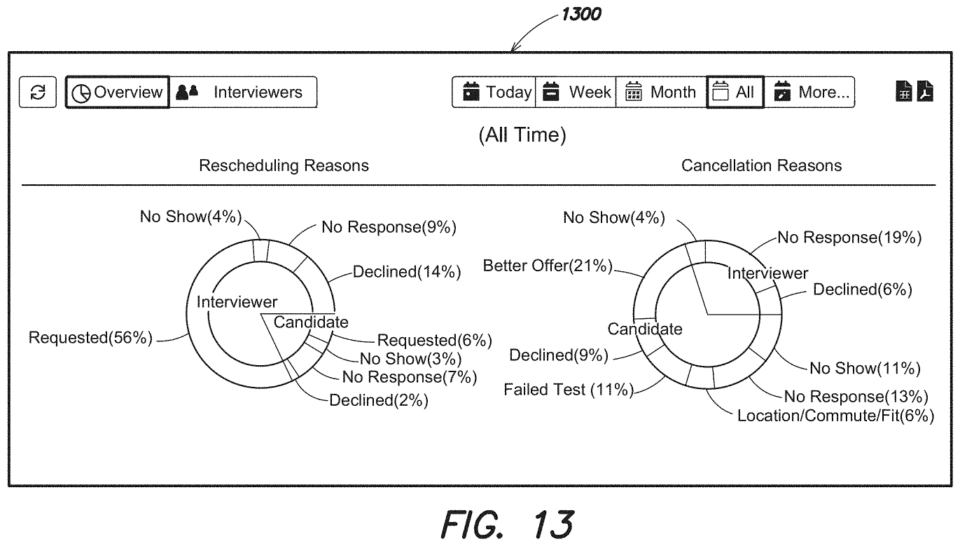

FIG. 12 shows an example interface showing detailed statistics showing user performance relating to an event-setting process according to some embodiments. Additionally, FIG. 13 shows one example interface showing reasons for cancellation of an event (e.g., an interview event) according to some embodiments in a graphical format.

(6) Interview Automation with Messaging Bots

In some embodiments, the system may implement defined rules to automatically cancel interviews when candidates or interviewers decline, optionally using messaging (e.g., SMS, WhatsApp, Slack, Teams, etc.) to ask the coordinator to reschedule instead of cancel.

### Example Implementation

1. Rule: Automatically Cancel interviews when candidates or interviewers decline.
   a. When this rule is enabled, the scheduled interview will be automatically cancelled if either the candidate or one of the interviewers decline (e.g., by entering a response within a messaging interface that the event is declined by the user/interviewer).
2. Rule: Automatically send an invite to the candidate if all the interviewers accept.
   a. When all the interviewers accept the event invite, the next step is to send the invite to the candidate. On enabling this rule the scheduler won't have to manually check the response statuses and then send the candidate the invite, The coordination system will automatically send the invitation to the candidate as soon as all the interviewers accept.
3. Rule: Prompt the scheduler to take action when the candidate or any of the interviewers decline.
   a. When any of the interviewers or the candidate declines the event invite, The coordination system will send a notification on the scheduler's preferred communication channel (e.g., Slack, MS Teams, WhatsApp, etc.) with the option to either reschedule the event (e.g., interview) or cancel the event.
4. Rule: Send the interviewers/candidate a notification if they have not replied to the event invite x hours before the interview start time.

Technical Elements:

In some implementations, reminders and notifications (time based) are handled using Google Cloud Tasks and Firebase Functions.
1. During scheduling/rescheduling a cloud task is enqueued to be set off at a predetermined time (e.g., x hours before the interview start time).
2. The cloud task triggers a Firebase function when it is set off.
3. The Firebase function handles the notification logic and the contextual data is provided by the cloud task's payload.

In some implementations, some automations (like 1, 2 and 3 above) are event-based and are triggered by certain events (e.g., some user declining the invite). The trigger and the action performed can be customized individually.

(7) Automatically/Optionally Adding all Interviewers as Alternate Hosts to Web Conferencing

When interviews are scheduled by coordinators, in some embodiments, all interviewers are added by the coordination system as alternate hosts to web conferences so they can start/stop/control the web conference when the coordinator is not an interviewer.

### Example

1. While scheduling a webconference, the “alternate_hosts” are added to the API request body. The coordination system checks if the email (that needs to be added to the list of alternate hosts) is “authorized” to become a host and if it is, the coordination system adds the host to the list of alternate hosts.

(8) Automatically Adding Interviews on Secondary Calendars or Marking Event as Free

When interviews are scheduled by coordinators, in some embodiments, the interview is automatically put onto a secondary calendar (e.g., for Google GSuite) or marked as “free” (e.g., for Office 365) when the coordinator is not an interviewer, so that the coordinator's calendar is not overbooked.

### Example

1. Google:
   a. While scheduling, the coordination system (e.g., referred to herein as the “Rooster” platform) checks if the scheduler is one of the interviewers.
      i. If true, the Rooster platform (“Rooster”) uses the scheduler's primary calendar to organize the event. This marks the event as “busy” on the organizer's primary calendar.
      ii. If false, Rooster uses the secondary calendar (e.g., referred to herein as Rooster Interviews) of the organizer for scheduling the event so that his/her primary calendar remains free.
2. Office365:
   a. While scheduling, Rooster checks if the scheduler is one of the interviewers.
      i. If true, Rooster uses the scheduler's primary calendar to organize the event and marks the event as “busy” for the organizer (In O365 we can choose to make the event busy or free for the organizer alone without affecting the “visibility” for the attendees)
      ii. If false, Rooster still uses the scheduler's primary calendar and marks the event as “busy” but then updates the organizer's copy of the event to mark it “free” for the organizer.

(9) Showing Zoom and Webex Video Conference Availability on Calendar

When scheduling video conference interviews, the Zoom and Webex video conferences already in use are shown on the calendar, so that the Zoom and Webex account is not overbooked.

### Example Implementation

1. The client side sends a list of conferences along with a startTime and endTime for which Rooster checks the availability.
2. Rooster queries the events (e.g., via an API call to list events) for each conference in the provided list and checks if the conference is free/busy during the provided start and end times.
3. Rooster returns the array of free/busy conferences back to the client which the client uses to show/hide conferences based on whether they are available during the specified time.

(10) Sharing of Calendar, Email and Video Conferencing Accounts

When scheduling interviews, the calendar, email and video conferencing accounts can be shared with other team members to facilitate scheduling using shared accounts.

### Example Implementation

1. To share a grant, the user simply needs to click on the “share grant” option for the respective grant he/she owns.
2. Rooster sets a flag in the grant document that tells the system that it is shared.
3. After the flag is set, all schedulers for a particular rooster tenant can see (and use) the shared grant.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments. The computer-readable storage medium can be transportable such that the program stored thereon can be loaded onto any computer resource to implement the aspects discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects.

Various aspects may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
a plurality of computer-implemented domains, each domain comprising a plurality of users, each of which includes at least one calendar database comprising a plurality of events;
a coordination element configured to perform an inter-domain function among at least two calendar databases associated with two respective users, the two users located within different domains, wherein the coordination element is adapted to query the at least two calendar databases associated with the two respective users of the different domains and determine at least one potential common attribute for determining a new event;
communicating the at least one common attribute for a proposed new event; and
creating, responsive to indications from the two respective users that the proposed new event is accepted, events in each one of the calendar databases of the two respective users.

2. The system according to claim 1, wherein the at least one common attribute is an availability indication among the calendar databases of the two respective users.

3. The system according to claim 1, wherein the coordination element is adapted to coordinate with a plurality of computer platform types associated with the plurality of computer-implemented domains, wherein the plurality of computer platform types includes a group comprising:
a messaging system;
an email system;
a calendar management system;
a conferencing system;
a location management system; and
an applicant tracking system (ATS).

4. The system according to claim 1, wherein the coordination element is configured to perform at least one function.

5. The system according to claim 4, wherein the new event is a web conference, and wherein the at least one function comprises automatically adding, by the coordination system, additional users that did not create the web conference as alternate hosts to the web conference.

6. The system according to claim 5, wherein the additional users are permitted to manage the web conference independently of a creator of the web conference.

7. The system according to claim 4, wherein the coordination element is configured to automatically grant access rights to a shared account associated with the new event.

8. The system according to claim 7, wherein the shared account is at least one of a group comprising a calendar account, an email account, or a video conferencing account.

9. The system according to claim 7, wherein the coordination element is configured to automatically grant rights to a group of users to the shared account.

10. The system according to claim 1, further comprising an interface adapted to permit a managing user to create a rule that controls the coordination element to perform at least one action.

11. The system according to claim 10, wherein the rule controls the coordination element to automatically cancel the new event when one or more users associated with the new event decline to attend the new event within a computer interface.

12. The system according to claim 10, wherein the rule controls the coordination element to automatically place the new event on a secondary calendar of a coordinating user that created the new event.

13. The system according to claim 10, wherein the rule controls the coordination element to automatically mark the new event as free on a calendar of a coordinating user that created the new event.

14. The system according to claim 11, wherein the coordination element is configured to automatically send a message to a coordinating user to reschedule the new event responsive to receiving an indication of a declination to attend the new event by the one or more users associated with the new event, at least two of the one or more users being assigned to different domains.

15. The system according to claim 1, wherein a user component is adapted to send the coordination element a requested new event with at least a start time and an end time, and a plurality of invited users for the requested new event.

16. The system according to claim 15, wherein the coordination element is adapted to determine if the plurality of invited users are available to attend the requested new event.

17. The system according to claim 16, wherein the coordination element is adapted to return an indication of a common availability of the one or more users associated with the new event.
